(19) United States
(12) Patent Application Publication
(10) Pub. No.: US 2026/0193988 A1
(43) Pub. Date: Jul. 9, 2026

(54) TURBINE BLADE

(71) Applicant: MITSUBISHI HEAVY INDUSTRIES, LTD., Tokyo (JP)

(72) Inventors: Satoshi MIZUKAMI, Tokyo (JP); Ryuta ITO, Tokyo (JP); Shuji TANIGAWA, Tokyo (JP); Atsuya SAKATA, Tokyo (JP); Saki MATSUO, Tokyo (JP); Yamato SHIRAMASA, Tokyo (JP); Ryo TANAKA, Tokyo (JP); Yusuke AKADA, Tokyo (JP)

(21) Appl. No.: 19/128,301

(22) PCT Filed: Nov. 24, 2023
(86) PCT No.: PCT/JP2023/042103

§ 371 Date: May 8, 2025

(30) Foreign Application Priority Data
Nov. 28, 2022 (JP) 2022-189168

(51) Int. Cl. F01D 5/18

(52) U.S. Cl. CPC F01D 5/189; F05D 2250/182; F05D 2260/201; F05D 2260/2214

(57) ABSTRACT

A turbine blade including a blade wall and an insert inserted in a space formed inside the blade wall. Inside the insert, an inner cavity communicating with the outside of the turbine blade is formed. On the outer surface of the insert, a plurality of projections projecting toward the inner surface of the blade wall are formed. Between two adjacent projections among the plurality of projections, a collection space communicating with the outside of the turbine blade is defined. Formed in each of the plurality of projections are a flow path communicating with the inner cavity, and at least one cooling hole that is open so as to communicate with the flow path and face the inner surface of the blade wall.

### TECHNICAL FIELD

The present disclosure relates to a turbine blade.

The present application claims priority based on Japanese Patent Application No. 2022-189168 filed in Japan on Nov. 28, 2022, the contents of which are incorporated herein by reference.

### BACKGROUND ART

PTL 1 discloses a turbine blade that can be cooled by impingement cooling. In the turbine blade, an insert is provided in a space formed inside a blade wall, a plurality of protrusion portions are formed in the insert, to protrude toward an inner surface of the blade wall, and a cooling hole for jetting a cooling medium is formed at a distal end of each protrusion portion. The blade wall can be cooled by collision of the cooling medium jetted from the cooling hole with the inner surface of the blade wall. The cooling medium colliding with the inner surface of the blade wall circulates in a collection space defined between adjacent protrusion portions and is then discharged to an outside of the turbine blade.

In a case where a phenomenon in which the cooling medium flows in a direction along the inner surface between the insert and the inner surface of the blade wall after the cooling medium collides with the inner surface of the blade wall, that is, a cross flow occurs, there is a concern that cooling efficiency of the blade wall is reduced due to interference of the cooling medium jetted from the cooling hole by the cross flow. Meanwhile, in the turbine blade disclosed in PTL 1, the cross flow can be reduced by allowing the cooling medium to circulate through the collection space after the cooling medium collides with the inner surface of the blade wall.

### CITATION LIST

### Patent Literature

[PTL 1] Japanese Unexamined Patent Application Publication No. 2015-63997

### SUMMARY OF INVENTION

### Technical Problem

However, since the turbine blade disclosed in PTL 1 has a complicated configuration, there is a concern that an effect of reducing a cross flow is weakened unless dimensions of each part are defined.

In view of the above-described circumstances, an object of at least one embodiment of the present disclosure is to provide a turbine blade having an enhanced reduction effect of the cross flow.

### Solution to Problem

In order to achieve the above-described object, a turbine blade according to the present disclosure is a turbine blade including a blade wall, and an insert inserted into a space formed inside the blade wall, in which an inner cavity communicating with an outside of the turbine blade is formed inside the insert, a plurality of protrusion portions protruding toward an inner surface of the blade wall are formed on an outer surface of the insert, a collection space communicating with the outside of the turbine blade is defined between two adjacent protrusion portions among the plurality of protrusion portions, in each of the plurality of protrusion portions, a flow path communicating with the inner cavity and at least one cooling hole communicating with the flow path and open to face the inner surface of the blade wall are formed, and in at least one cross section of the turbine blade perpendicular to a blade height direction of the turbine blade between a tip side edge and a hub side edge of the turbine blade, a length in which at least one protrusion portion among the plurality of protrusion portions extends from the outer surface of the insert toward the inner surface of the blade wall is defined as a length of the at least one protrusion portion, and in a case where the length of the at least one protrusion portion is defined as L and an inner diameter of the at least one cooling hole formed in the at least one protrusion portion is denoted as d, L>5d is satisfied.

### Advantageous Effects of Invention

With the turbine blade according to the present disclosure, it is possible to increase a flow path cross-sectional area of a collection space without reducing a width of the flow path. Therefore, it is possible to enhance a reduction effect of a cross flow.

### BRIEF DESCRIPTION OF DRAWINGS

FIG. 1 is a schematic configuration view of a gas turbine in which a turbine blade according to an embodiment of the present disclosure is used.

FIG. 2 is a view in which a turbine blade according to an embodiment of the present disclosure is viewed in a direction from a pressure surface toward a negative pressure surface.

FIG. 3 is a cross-sectional view taken along line III-III of FIG. 2.

FIG. 4 is an enlarged cross-sectional view of a portion of an insert of a turbine blade according to an embodiment of the present disclosure.

FIG. 5 is a cross-sectional view for describing an orientation of a cooling hole with respect to an inner surface of a blade wall in a turbine blade according to an embodiment of the present disclosure.

FIG. 6 is a view showing a relative positional relationship between a flow path and a cooling hole in a protrusion portion of an insert of a turbine blade according to an embodiment of the present disclosure.

FIG. 7 is a cross-sectional view for describing a configuration of a plurality of protrusion portions of an insert of a turbine blade according to an embodiment of the present disclosure.

FIG. 8 is a cross-sectional view for describing a configuration of a plurality of protrusion portions of an insert of a turbine blade according to an embodiment of the present disclosure.

FIG. 9 is a perspective view for describing a configuration of a plurality of protrusion portions of an insert of a turbine blade according to an embodiment of the present disclosure.

FIG. 10 is a view showing an operational effect in a case where an arrangement of a plurality of cooling holes formed in a plurality of protrusion portions of an insert of a turbine blade according to an embodiment of the present disclosure is set as a staggered arrangement.

FIG. 11 is a diagram showing an operational effect in a case where an arrangement of a plurality of cooling holes formed in a plurality of protrusion portions of an insert of a turbine blade according to an embodiment of the present disclosure is a staggered arrangement.

FIG. 12 is a diagram showing an operational effect in a case where an arrangement of a plurality of cooling holes formed in a plurality of protrusion portions of an insert of a turbine blade according to an embodiment of the present disclosure is set as a staggered arrangement.

### DESCRIPTION OF EMBODIMENTS

Hereinafter, a turbine blade according to embodiments of the present disclosure will be described with reference to the drawings. The embodiments which will be described below show aspects of the present disclosure and do not limit the disclosure, and any change can be made within the scope of the technical idea of the present disclosure.

<Configuration of Gas Turbine in which Turbine Blade of Present Disclosure is Used>

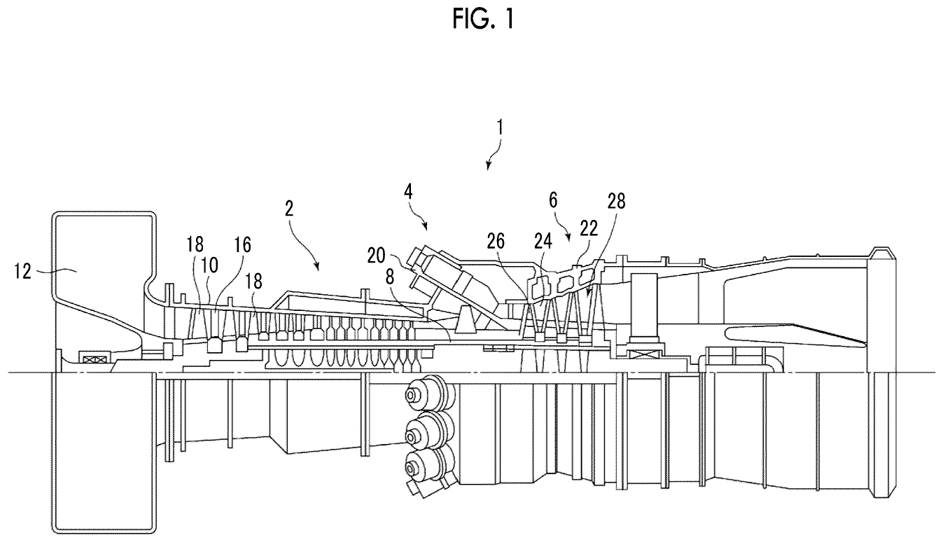

As shown in FIG. 1, a gas turbine 1 includes a compressor 2 for generating compressed air, a combustor 4 for generating combustion gas using the compressed air and fuel, and a turbine 6 configured to be rotationally driven by the combustion gas. In a case of the gas turbine 1 for power generation, a generator (not shown) is connected to the turbine 6.

The compressor 2 includes a plurality of stator blades 16 fixed to a compressor casing 10 side and a plurality of rotor blades 18 attached to a rotor 8. Air taken in from an air intake port 12 is sent to the compressor 2, and the air passes through the plurality of stator blades 16 and the plurality of rotor blades 18 and is compressed to be high-temperature and high-pressure compressed air.

The combustor 4 is configured to be supplied with the fuel and the compressed air generated by the compressor 2, and the fuel and the compressed air are mixed and then burned in the combustor 4 to generate combustion gas that is an operating fluid for the turbine 6. A plurality of combustors 4 may be disposed in a casing 20 along a circumferential direction around the rotor.

The turbine 6 includes a combustion gas passage 28 formed in a turbine casing 22, and a plurality of stator blades 24 and a plurality of rotor blades 26 provided in the combustion gas passage 28. The stator blade 24 is fixed to a side of the turbine casing 22, and a stator blade row is configured with the plurality of stator blades 24 arranged along a circumferential direction of the rotor 8. Further, the rotor blade 26 is attached to the rotor 8, and a rotor blade row is configured with the plurality of rotor blades 26 arranged along the circumferential direction of the rotor 8. The stator blade row and the rotor blade row are alternately arranged in an axial direction of the rotor 8.

### <Configuration of Turbine Blade of Present Disclosure>

The turbine blade of the present disclosure is applicable to both the stator blade 24 and the rotor blade 26 of the turbine 6. Hereinafter, a turbine blade according to an embodiment of the present disclosure will be described as the stator blade 24, but may be the rotor blade 26.

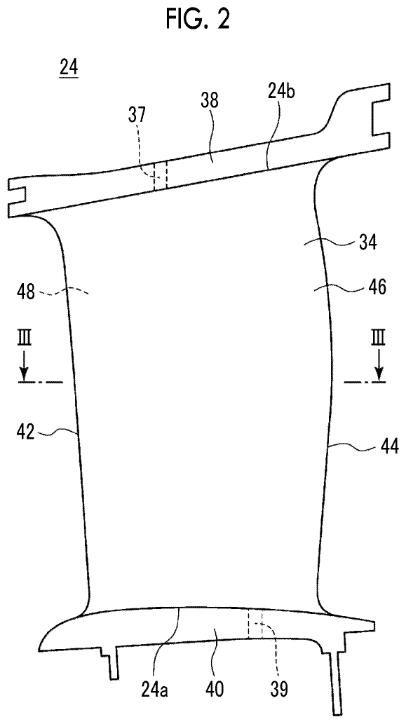

As shown in FIG. 2, the stator blade 24 includes a blade wall 34, and the blade wall 34 extends in a direction from a hub side edge 24a toward a tip side edge 24b of the stator blade 24, that is, in a blade height direction of the stator blade 24. An outer shroud 38 and an inner shroud 40 are provided on each of the tip side edge 24b and the hub side edge 24a. The blade wall 34 has a leading edge 42 and a trailing edge 44 extending along the blade height direction, and has a pressure surface 46 and a negative pressure surface 48 extending between the leading edge 42 and the trailing edge 44.

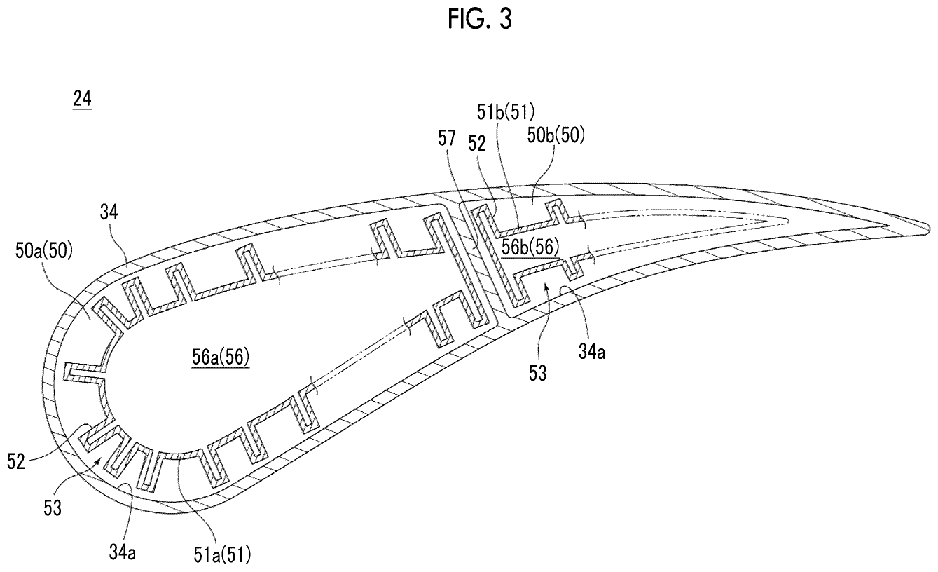

As will be described later, a space 50 (refer to FIG. 3) is formed inside the blade wall 34, and paths 37 and 39 that communicate with an outside of the stator blade 24 and with the space 50 are formed in each of the outer shroud 38 and the inner shroud 40. Forms of the paths 37 and 39 are not limited to forms formed in each of the outer shroud 38 and the inner shroud 40 and may be formed in any one of the outer shroud 38 and the inner shroud 40. In FIG. 2, each of the paths 37 and 39 is schematically shown to be provided one by one, but each of the paths 37 and 39 or any one of the paths 37 and 39 may be provided in a plurality. Roles of the paths 37 and 39 will be described below.

As shown in FIG. 3, the space 50 is formed inside the blade wall 34. The space 50 may be divided by a partition wall 57 into a plurality of spaces, for example, two spaces 50a and 50b. The space 50 may be divided into three or more spaces by two or more partition walls 57, or the space 50 may be set as one space without providing the partition wall 57. An insert 51 is inserted into the space 50. As shown in FIG. 3 as an example, in a case where the space 50 is divided into two spaces 50a and 50b, the insert 51 may include inserts 51a and 51b inserted into each space.

### <Configuration of Insert>

Each of the inserts 51a and 51b has a shape having a longitudinal direction axis along the blade height direction (direction perpendicular to a paper surface of FIG. 3) of the stator blade 24, and inner cavities 56 (56a and 56b) are formed inside each of the inserts 51a and 51b. A plurality of protrusion portions 52 that protrude toward an inner surface 34a of the blade wall 34 are formed on an outer surface of each of the inserts 51a and 51b. In each of the inserts, the plurality of protrusion portions 52 extend along the blade height direction of the stator blade 24 and are formed to be arranged with an interval in the circumferential direction around the longitudinal direction axis.

The path 37 (refer to FIG. 2) communicates with each of the inner cavities 56a and 56b in the spaces 50a and 50b, and the path 39 communicates with a region between the outer surface of each of the inserts 51a and 51b in the spaces 50a and 50b and the inner surface 34a of the blade wall 34, particularly in each of the inserts in the spaces 50a and 50b, communicates with a collection space 53 defined between the protrusion portions 52 and 52 adjacent to each other in the circumferential direction around the longitudinal axis direction.

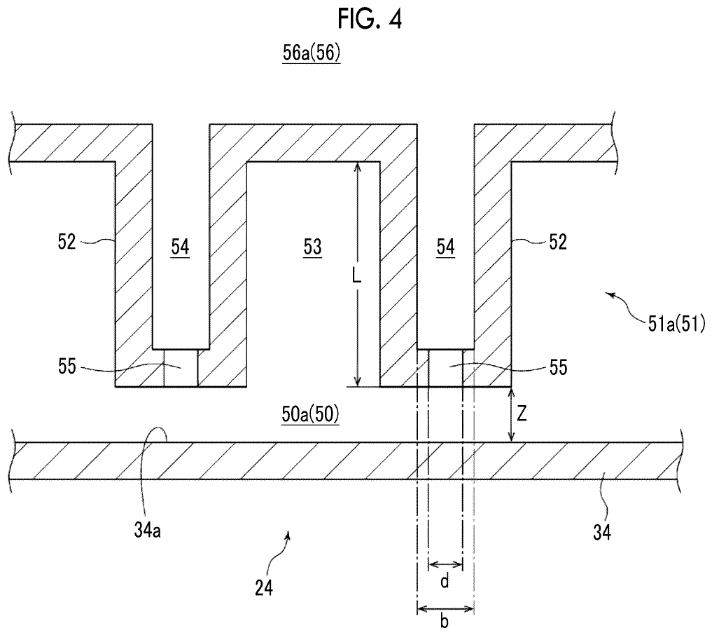

Next, a configuration of the protrusion portion 52 will be described. FIG. 4 is a cross-sectional view of some of the plurality of protrusion portions 52 provided in the insert 51a. The configuration of the protrusion portion 52 described below with reference to FIG. 4 also applies to all or some of the plurality of protrusion portions 52 provided in the other insert 51b.

A flow path 54, which is a cavity communicating with the inner cavity 56a, is formed inside the protrusion portion 52. In addition, the protrusion portion 52 is formed with a cooling hole 55 communicating with the flow path 54 and is open to face the inner surface 34a of the blade wall 34. In FIG. 4, a description is shown in which one cooling hole 55 is formed in each protrusion portion 52. However, the present disclosure is not limited to the configuration in which only one cooling hole 55 is formed. As described above, since the protrusion portion 52 has a shape extending along the blade height direction of the stator blade 24, that is, in a direction perpendicular to a paper surface of FIG. 4, for example, a plurality of cooling holes 55 may be formed with intervals in this direction between each other.

The protrusion portions 52 may be disposed at equal intervals to uniformly cool the entire stator blade 24, or an interval between the adjacent protrusion portions 52 and 52 in a location to be particularly cooled may be set to be smaller than the interval between the adjacent protrusion portions 52 and 52 in another location. For example, an interval between the protrusion portions 52 and 52 disposed on a pressure side of the stator blade 24 may be set to be smaller than an interval between the protrusion portions 52 and 52 disposed on a suction side of the stator blade 24. Further, the protrusion portions 52 disposed on each of the pressure side and the suction side of the stator blade 24 may be disposed such that the interval between the adjacent protrusion portions 52 and 52 gradually increases from a leading edge toward a trailing edge of the stator blade 24. In addition, the number of cooling holes 55 formed in the protrusion portion 52 facing the location to be particularly cooled may be set to be larger than the number of cooling holes 55 formed in the protrusion portion 52 facing another location.

For example, in a case where it is found that a specific location reaches a high temperature with actual measurement or simulation, the space 50 may be divided into a plurality of spaces by the partition wall 57, and the number of protrusion portions 52 formed on the insert 51 inserted into a space in which the specific location reaching a high temperature is present may be set to be larger than the number of protrusion portions 52 formed on the insert 51 inserted into another space, so that the interval between the adjacent protrusion portions 52 and 52 in the former may be set to be smaller than the interval between the adjacent protrusion portions 52 and 52 in the latter. In this case, instead of changing the number of protrusion portions 52, the number of cooling holes 55 in the former may be set to be larger than the number of cooling holes 55 in the latter.

For example, in a case where it is found that a temperature of the pressure side of the stator blade 24 is higher than a temperature of the suction side of the stator blade 24 by the actual measurement or the simulation, the number of cooling holes 55 formed in the protrusion portion 52 on the pressure side of the stator blade 24 may be set to be larger than the number of cooling holes 55 formed in the protrusion portion 52 on the suction side of the stator blade 24. On the contrary, in a case where it is found that the temperature of the suction side of the stator blade 24 is higher than the temperature of the pressure side of the stator blade 24, the number of cooling holes 55 formed in the protrusion portion 52 on the suction side of the stator blade 24 may be set to be larger than the number of cooling holes 55 formed in the protrusion portion 52 on the pressure side of the stator blade 24.

In a case where a plurality of cooling holes 55 are formed in each protrusion portion 52, the interval between the adjacent cooling holes 55 and 55 may be an equal interval or may be a different interval. In the latter configuration, for example, the interval between the adjacent cooling holes 55 and 55 may gradually increase from a hub side toward a tip side, or conversely, the interval between the adjacent cooling holes 55 and 55 may gradually increase from the tip side toward the hub side.

### <Cooling Operation of Blade Wall in Turbine Blade of Present Disclosure>

A cooling operation of the blade wall in the turbine blade of the present disclosure will be described. As shown in FIG. 2, a cooling medium (for example, cooling air) is supplied from the outside of the stator blade 24 to the inside of the blade wall 34 through the path 37. As shown in FIG. 3, the cooling medium flows into each of the inner cavities 56a and 56b. For example, the cooling medium that flows into the inner cavity 56a flows into the flow path 54 as shown in FIG. 4, then flows into the cooling hole 55, and is jetted from the cooling hole 55 toward the inner surface 34a of the blade wall 34. The cooling medium jetted from the cooling hole 55 collides with the inner surface 34a of the blade wall 34, so that the blade wall 34 is cooled. The cooling medium collides with the inner surface 34a of the blade wall 34, is introduced into the collection space 53 defined between the adjacent protrusion portions 52 and 52, and is discharged to the outside of the stator blade 24 through the path 39 (refer to FIG. 2).

After the cooling medium collides with the inner surface 34a of the blade wall 34, a phenomenon occurs in which the cooling medium flows in a direction along the inner surface 34a in a vicinity of another cooling hole 55, that is, a cross flow, there is a concern that cooling efficiency is reduced due to interference of the cooling medium jetted from the other cooling hole 55 by the cross flow. However, in the stator blade 24 having the above-described configuration, the cooling medium is introduced into the collection space 53 after colliding with the inner surface 34a of the blade wall 34. Therefore, the cross flow can be reduced, and as a result, it is possible to reduce a probability that the cooling efficiency of the blade wall 34 is reduced.

### <Operational Effect of Turbine Blade of Present Disclosure>

As shown in FIG. 4, it is preferable that a length L over which the protrusion portion 52 extends from the outer surface of the insert 51a toward the inner surface 34a of the blade wall 34 is as long as possible. In this way, a flow path cross-sectional area of the collection space 53 can be increased without reducing a width of the flow path 54. Therefore, a reduction effect of the cross flow can be enhanced. Specifically, it is preferable to design the length L of the protrusion portion 52 such that L>5d is satisfied.

Next, a configuration for further enhancing such a reduction effect of the cross flow will be described. In a cross section of the space 50a shown in FIG. 3, an area of the inner cavity 56a is denoted as A₁, and a total area of the collection space 53 is denoted as A₂. The area A₁ only affects a pressure loss or a pressure distribution of the cooling medium flowing through the inner cavity 56a. On the other hand, the area A₂ affects not only a pressure loss or a pressure distribution of the cooling medium flowing through the collection space 53 but also the cross flow or a heat transfer coefficient. Therefore, the latter is a more important factor than the former. Therefore, it is preferable to make the area A₂ as large as possible, and examples of a condition for realizing this include the above-described L>5d. In addition to this condition, it is preferable that A₁<A₂ is satisfied as a more direct condition.

### <Additional Configuration of Insert>

Hereinafter, some additional configurations that are not essential will be described for each of the inserts 51a and 51b. Hereinafter, the configuration of the insert 51a will be described, but the same configuration can be applied to the insert 51b unless otherwise specified.

### <Additional Configuration 1>

As shown in FIG. 4, in a case where a distance between an opening of the cooling hole 55 and the inner surface 34a is denoted as Z, it is preferable that 1<Z/d<5 is satisfied. In general, it is considered that, the larger Z is, an area of a flow of the cooling medium crossing a flow of the cooling medium jetted from the cooling hole 55 (the flow of the cooling medium along an axial direction of the collection space 53 after colliding with the inner surface 34a) can be secured, and thus there is a desirable effect on cooling of the blade wall 34. However, in a case where Z/d≥5 is satisfied, a flow velocity is reduced until the cooling medium jetted from the cooling hole 55 reaches the inner surface 34a, and there is a concern that an ability to cool the blade wall 34 is reduced. Therefore, the condition of Z/d<5 is preferable. On the other hand, in a case where Z/d≤1 is satisfied, a pressure loss between the opening of the cooling hole 55 and the inner surface 34a increases, and the flow velocity of the cooling medium jetted from the cooling hole 55 decreases. In order to secure a pressure loss that can realize a flow velocity suitable for cooling the blade wall 34 by means of the cooling medium jetted from the cooling hole 55, it is preferable that the condition of 1<Z/d is satisfied.

### <Additional Configuration 2>

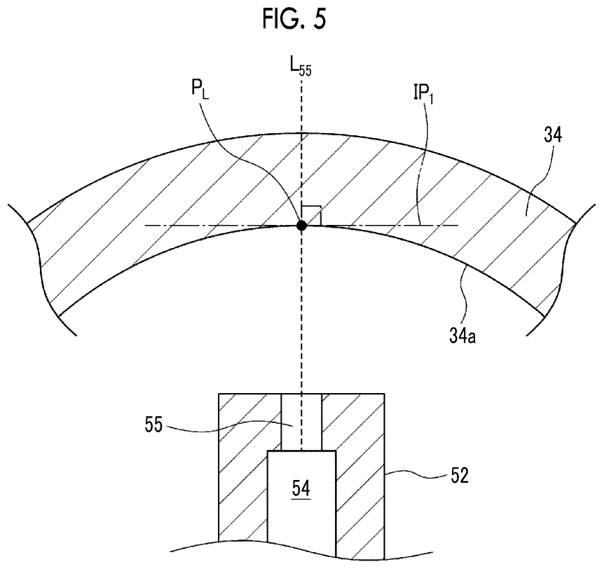

It is preferable that the cooling hole 55 is surface-perpendicular to the inner surface 34a of the blade wall 34. With such a configuration, the cooling medium efficiently collides with the inner surface 34a, and thus the blade wall 34 can be efficiently cooled. However, the inner surface 34a is not necessarily a flat surface, and there is a possibility that the configuration in which the cooling hole 55 is surface-perpendicular to the curved inner surface 34a is considered to be unclear. Therefore, as shown in FIG. 5, “surface-perpendicular” is defined as “assuming that a virtual tangent plane IP₁ is in contact with the inner surface 34a at a position P_{L} where an axis L₅₅ of the cooling hole 55 intersects the inner surface 34a of the blade wall 34, the axis L₅₅ intersects the virtual tangent plane IP₁ perpendicularly” in consideration of a case where the inner surface 34a is curved. For this purpose, the present invention is not limited to the cooling hole 55 being strictly surface-perpendicular to the inner surface 34a of the blade wall 34, that is, the axis L₅₅ intersects the virtual tangent plane IP₁ strictly perpendicularly, and a configuration in which the cooling hole 55 is approximately surface-perpendicular to the inner surface 34a of the blade wall 34, that is, a configuration in which an angle formed by the axis L₅₅ with respect to the virtual tangent plane IP₁ is within a range of 90°±10° may be adopted. Since the cooling holes 55 are approximately surface-perpendicular to the inner surface 34a of the blade wall 34, the plurality of protrusion portions 52 are disposed approximately radially along the inner surface 34a on a leading edge side of the stator blade 24.

### <Additional Configuration 3>

A length of the flow path 54 in a direction (in FIG. 4, a left-right direction) in which the plurality of protrusion portions 52 are arranged is defined as a “width of the flow path 54”. In FIG. 4, the width of the flow path 54 is constant in a direction (downward in FIG. 4) protruding toward the inner surface 34a of the protrusion portion 52, but there is also a configuration in which the width increases toward the cooling hole 55 or a configuration in which the width decreases toward the cooling hole 55. Therefore, in such a configuration, it is not possible to specify which length is referred to as the “width of the flow path 54”. Therefore, regardless of the configuration of the flow path 54, in a case where the width of the flow path 54 at a position in which the flow path 54 is connected to the cooling hole 55, that is, at a lowest position in FIG. 4, is denoted as b, and an inner diameter of the cooling hole 55 is denoted as d, b/d≥1.2 is satisfied.

As described above, from a viewpoint of reducing the cross flow, it is preferable that the flow path cross-sectional area of the collection space 53 is large. Therefore, while it is necessary to reduce the width of the protrusion portion 52, that is, the width of the flow path 54, a ratio b/d is a value close to 1 from a viewpoint in which it is necessary to ensure a certain size of the inner diameter d of the cooling hole 55, in terms of a jetting amount of the cooling medium. On the other hand, in the stator blade 24 of the present disclosure, b/d≥1.2 is satisfied. In order to describe the operational effect of this configuration, a manufacturing method of the stator blade 24, particularly, the manufacturing method of the inserts 51a and 51b, is related. Therefore, the operational effect will be described while the manufacturing method of the stator blade 24 is described.

As shown in FIG. 3, the stator blade 24 is manufactured by molding the blade wall 34, molding the inserts 51a and 51b, and combining the blade wall 34 with the inserts 51a and 51b. It is preferable that the insert having a complicated shape such as the inserts 51a and 51b is molded by AM. In a case where the inserts 51a and 51b are molded by AM, in the molding of the inserts 51a and 51b, an intermediate body of the inserts 51a and 51b is laminated and formed using a metal powder material, and then the cooling hole 55 is machined in the protrusion portion 52 of the intermediate body as shown in FIG. 4. In a case of laminating and forming the intermediate body, a temporary hole for the cooling hole 55 may be molded in the protrusion portion 52 of the intermediate body, and the cooling hole 55 may be formed by finishing the temporary hole, or the cooling hole may be formed by machining without molding the temporary hole in the protrusion portion 52 of the intermediate body in a case of laminating and forming the intermediate body. The temporary hole formed in the intermediate body has a configuration in which the temporary hole communicates with the flow path 54 and is open on the outer surface of the protrusion portion 52, similarly to the cooling hole 55.

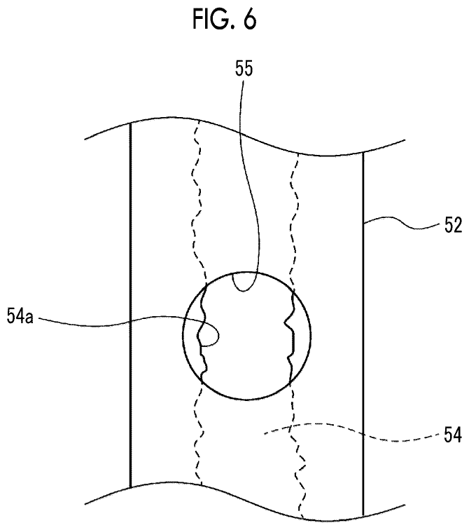

In general, a surface of the molded product by AM is rough, and a protrusion by sputtering may adhere to the surface. Therefore, in a case where the inserts 51a and 51b are molded by AM, a variation may occur in a width b of the flow path 54 and an inner diameter d of the cooling hole 55. The inner diameter d of the cooling hole 55 can be finished with high accuracy by machining or finishing after AM, but since it is difficult for a tool to access the inside (flow path 54) of the protrusion portion 52 due to a structure of the inserts 51a and 51b, the variation in the width b of the flow path 54 cannot be reduced. In that case, in a case where the ratio b/d is close to 1, as shown in FIG. 6, for example, a state in which the protrusion or the like on a surface 54a of the flow path 54 can be visible may occur in a case of viewing the inside (flow path 54) of the protrusion portion 52 from the cooling hole 55. In addition, even in a case where occurrence of the variation in the width b of the flow path 54 and the inner diameter d of the cooling hole 55 is suppressed as much as possible, as the ratio b/d reaches 1, in a case where a relative position between the cooling hole 55 and the flow path 54 deviates during the molding of the insert, the surface 54a of the flow path 54 is likely to be visible through the cooling hole 55. In such a state, as shown in FIG. 4, in a case of cooling the blade wall 34 by allowing the cooling medium to collide with the inner surface 34a, the flow of the cooling medium that flows from the flow path 54 to the cooling hole 55 is disturbed, so that there is a concern that the cooling efficiency of the blade wall 34 is reduced.

On the other hand, by setting the width b of the flow path 54 to be larger than the inner diameter d of the cooling hole 55, even in a case where the width b of the flow path 54 varies or the relative position between the cooling hole 55 and the flow path 54 deviates, the cooling hole 55 is accommodated within the width of the flow path 54. In order to obtain such an operational effect, in studies by the inventors of the present disclosure, it is considered that b/d≥1.2 is preferably satisfied. However, the ratio b/d being larger does not necessarily mean it is better, and in a case where the ratio b/d is excessively increased, the reduction effect of the cross flow is decreased, and the pressure loss due to contraction is increased in a case where the cooling medium circulates from the flow path 54 to the cooling hole 55. In order to suppress such an adverse effect as much as possible, it is preferable that b/d≤1.5 is satisfied.

As described above, even in a case where the width b of the flow path 54 varies in a case where the insert inserted in the stator blade 24 is molded by AM, by setting the ratio b/d of the width b of the flow path 54 to the inner diameter d of the cooling hole 55 to 1.2 or more, it is possible to reduce a probability that the surface 54a of the flow path 54 is visible through the cooling hole 55 in a case of viewing the inside (flow path 54) of the protrusion portion 52 from the cooling hole 55. As a result, in a case where the blade wall 34 is cooled by allowing the cooling medium to collide with the inner surface 34a, the possibility that the flow of the cooling medium flowing from the flow path 54 into the cooling hole 55 is disturbed is reduced. Therefore, it is possible to reduce the probability that the cooling efficiency of the blade wall 34 is reduced.

### <Additional Configuration 4>

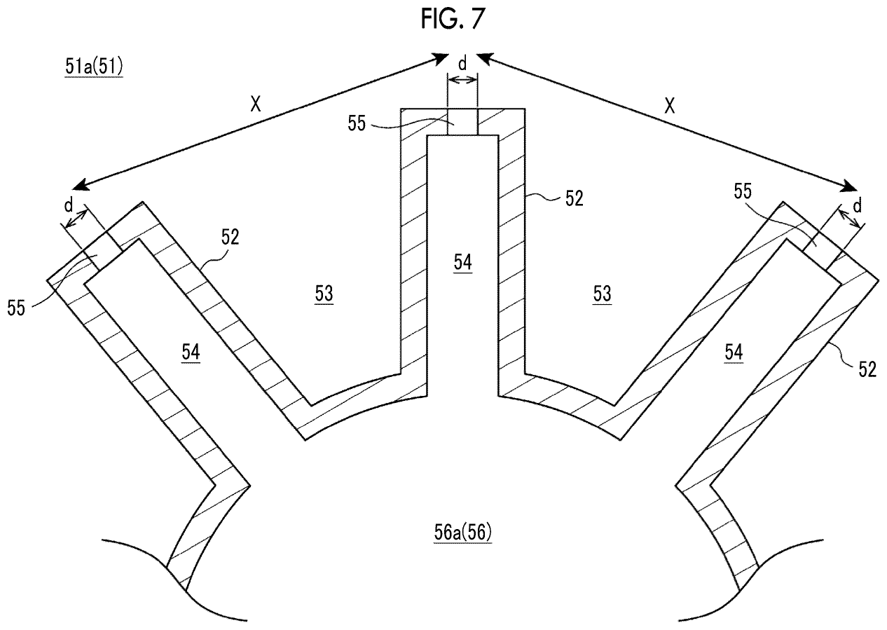

As shown in FIG. 7, in a cross section perpendicular to a length direction of the insert 51a (the blade height direction of the stator blade 24), as a pitch of distal ends of the adjacent protrusion portions 52 and 52 becomes larger, a flow rate of the cooling medium per unit area becomes smaller. Therefore, it is possible to efficiently cool the blade wall 34. In a case where the pitch of the distal ends of the adjacent protrusion portions 52 and 52 is denoted as X, and the inner diameter of the cooling hole 55 formed in the protrusion portion 52 is denoted as d, it is preferable that X/d≥10 is satisfied. However, the present invention is not limited to a configuration in which X/d≥10 is satisfied in the entire insert 51a, and a configuration may be adopted in which X/d≥10 is satisfied in at least a part of the insert 51a. In a case where a configuration in which X/d≥10 is satisfied in a part of the insert 51a is provided in the insert 51a, a cross flow is likely to occur. For example, it is preferable to provide a configuration in a vicinity of the tip side edge or in a vicinity of the hub side edge of the stator blade 24.

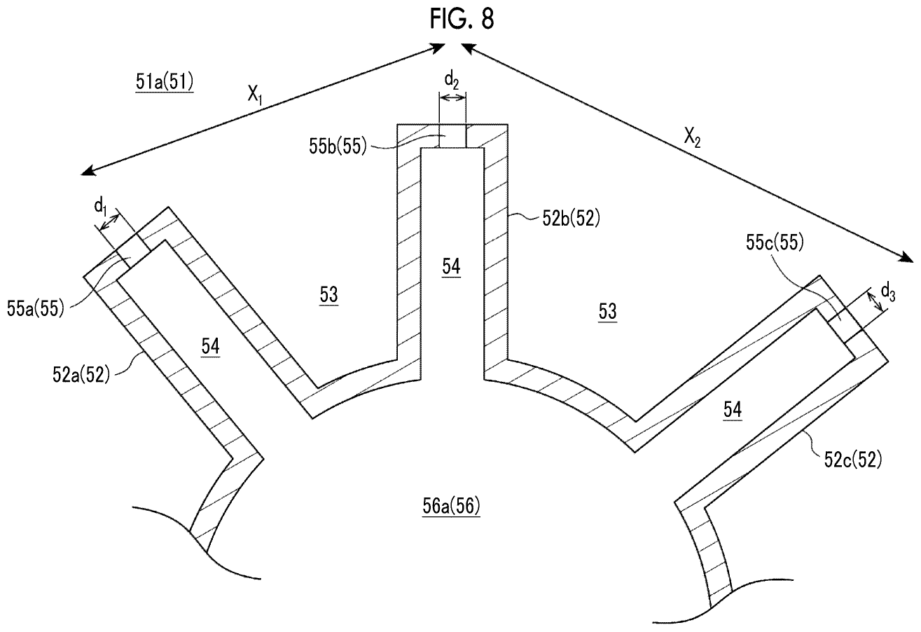

In FIG. 7, the pitch of the distal ends of the adjacent protrusion portions 52 and 52 and the inner diameter of the cooling hole 55 have the same configuration. However, a configuration in a case where these are different will be described with reference to FIG. 8. It is assumed that the plurality of protrusion portions 52 include a first protrusion portion 52a, a second protrusion portion 52b located adjacent to the first protrusion portion 52a, and a third protrusion portion 52c located adjacent to the second protrusion portion 52b on a side opposite to a side of the first protrusion portion 52a with respect to the second protrusion portion 52b. An inner diameter of a first cooling hole 55a, which is the cooling hole 55 formed in the first protrusion portion 52a, is denoted as d₁, an inner diameter of a second cooling hole 55b, which is the cooling hole 55 formed in the second protrusion portion 52b, is denoted as d₂, and an inner diameter of a third cooling hole 55c, which is the cooling hole 55 formed in the third protrusion portion 52c, is denoted as d₃. In addition, a pitch between a distal end of the first protrusion portion 52a and a distal end of the second protrusion portion 52b is denoted as X₁, and a pitch between the distal end of the second protrusion portion 52b and a distal end of the third protrusion portion 52c is denoted as X₂. In this way, a relationship in FIG. 8 corresponding to a relationship X/d≥10 in FIG. 7 satisfies [Expression 1].

$$\frac{{X}_{1}}{{d}_{1} + {d}_{2}} + \frac{{X}_{2}}{{d}_{2} + {d}_{3}} ≧ 10 \qquad [ Expression 1 ]$$

In this relationship, in a case where X₁=X₂=X and d₁=d₂=d₃=dis satisfied, X/d≥10 is satisfied.

In a case where two or more cooling holes 55 are formed in each protrusion portion 52 and inner diameters of the cooling holes 55 formed in each protrusion portion 52 are all the same, there is no particular problem with a value substituted for the above-described inequality of d (or d₁, d₂, and d₃). However, in a case where the plurality of cooling holes 55 having different inner diameters are formed in each protrusion portion 52, there is a problem as to which value should be substituted. In such a case, an average value of the inner diameters of the plurality of cooling holes 55 formed in each protrusion portion 55 may be calculated, and the average value may be substituted for d in the inequality. However, the “average value” is not limited to an arithmetic mean, and a geometric mean, a median value, or the like may be used.

### <Additional Configuration 5>

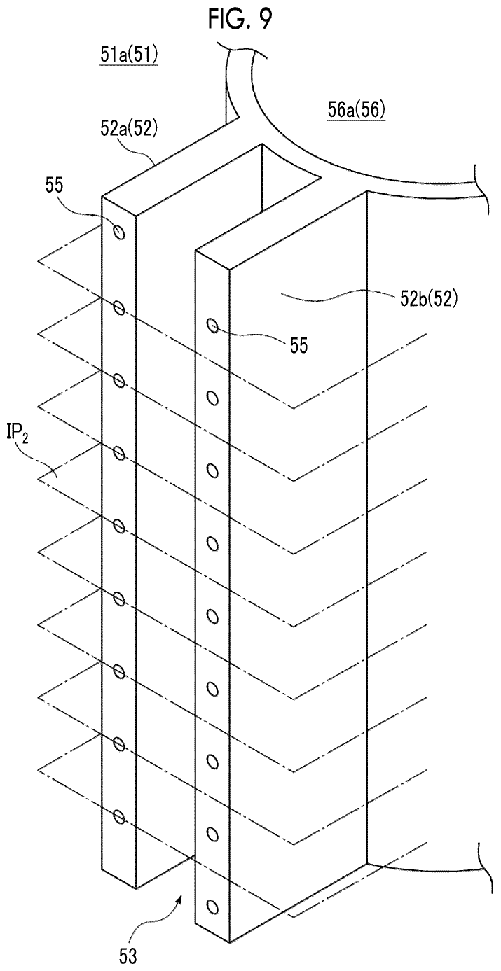

In FIG. 9, only the first protrusion portion 52a and the second protrusion portion 52b are exemplified as the plurality of protrusion portions 52, but the plurality of cooling holes 55 may be formed in each of the plurality of protrusion portions 52 without being limited to the two protrusion portions. It is preferable that the plurality of cooling holes 55 formed in each protrusion portion 52 are arranged in a row along the axial direction of the collection space 53. In general, as the flow velocity of the cooling medium flow that crosses the flow of the cooling medium jetted from the cooling holes 55 (hereinafter, referred to as “cross wind”) becomes smaller, the heat transfer coefficient increases, so that the ability to cool the blade wall 34 (refer to FIG. 3 and the like) is improved. In order to reduce an effect of the cross wind, in a case where the plurality of cooling holes 55 formed in each protrusion portion 52 are arranged in a row along the axial direction of the collection space 53, a direction of the cross wind changes due to interference between the flow of the cooling medium jetted from the cooling hole 55 located on a most upstream side with respect to the cross wind, and the cross wind. Therefore, the interference between the flow of the cooling medium jetted from the cooling hole 55 located on a downstream side for the cooling hole 55 located on the most upstream side with respect to the cross wind, and the cross wind is weakened. As a result, the ability to cool the blade wall 34 can be improved.

Further, it is preferable that the plurality of cooling holes 55 formed to be arranged in a row along the axial direction of the collection space 53 in each of the plurality of protrusion portions 52 are arranged in a staggered arrangement instead of a lattice arrangement. Here, the “staggered arrangement” means a configuration in which in a case where a plurality of virtual planes IP₂, which pass through each of the plurality of cooling holes 55 formed in the first protrusion portion 52a and are perpendicular to the axial direction of the collection space 53, are assumed, each of the plurality of virtual planes IP₂ passes through adjacent cooling holes 55 and 55 among the plurality of cooling holes 55 formed in the second protrusion portion 52b. On the other hand, the “lattice arrangement” means a configuration in which the virtual plane IP₂ passes through the cooling holes 55 formed in each of the adjacent protrusion portions.

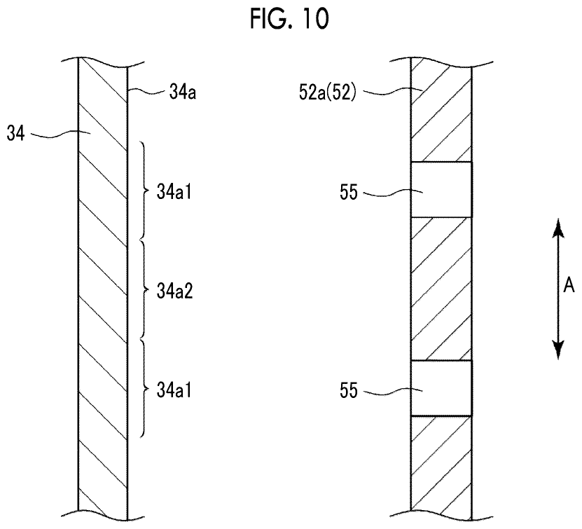

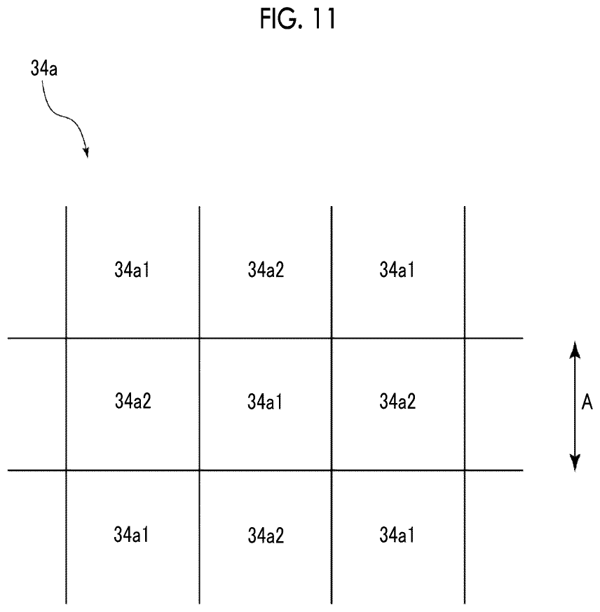

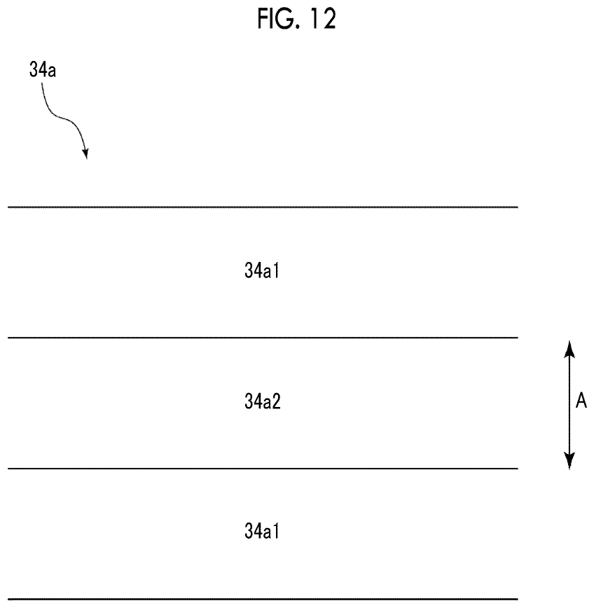

In a case where an arrangement of the cooling holes 55 is a staggered arrangement instead of the lattice arrangement, the following effects are obtained. As shown in FIG. 10, in a case of focusing on the two adjacent cooling holes 55 and 55 of the first protrusion portion 52a, in a region 34a2 of the inner surface 34a corresponding to a position near a center between the cooling holes 55 and 55 in an axial direction A of the collection space 53 (refer to FIG. 9), the cooling medium is less likely to be impinged than in a region 34al of the inner surface 34a corresponding to the position of the cooling hole 55 in the axial direction A. Therefore, a cooling effect in the region 34a2 is smaller than a cooling effect in the region 34al. That is, since the plurality of cooling holes 55 are arranged in a row with intervals, cooling unevenness occurs on the inner surface 34a in the axial direction A. On the other hand, in a case where the arrangement of the cooling holes 55 is set as a staggered arrangement, the region 34a2 in which the cooling effect by the cooling medium jetted from the cooling holes 55 of the first protrusion portion 52a is considered to be small and a region (region corresponding to the region 34al with respect to the first protrusion portion 52a) in which the cooling effect by the cooling medium jetted from the cooling holes 55 is considered to be large on the inner surface 34a facing the second protrusion portion 52b (refer to FIG. 9) adjacent to the first protrusion portion 52a are at the same position in the axial direction A. In this way, as shown in FIG. 11, the region 34al and the region 34a2 are present in a staggered shape on the inner surface 34a. In a case where the arrangement of the cooling holes 55 is set as a lattice arrangement, as shown in FIG. 12, the region 34al and the region 34a2 are in a stripe shape that is alternately present in the axial direction A. It is considered that a time required for the cooling effect of the inner surface 34a to be uniform by heat conduction in the blade wall 34 is shorter in the former state than in the latter state, and thus it is considered that the cooling unevenness of the entire inner surface 34a can be reduced.

For example, contents described in each of the above-described embodiments are understood as follows.

[1] A turbine blade according to an aspect is a turbine blade (a stator blade 24 and a rotor blade 26) including
a blade wall (34), and
an insert (51) inserted into a space (50) formed inside the blade wall (34),
in which an inner cavity (56) communicating with an outside of the turbine blade (24/26) is formed inside the insert (51),
a plurality of protrusion portions (52) protruding toward an inner surface (34a) of the blade wall (34) are formed on an outer surface of the insert (51),
a collection space (53) communicating with the outside of the turbine blade (24/26) is defined between two adjacent protrusion portions (52, 52) among the plurality of protrusion portions (52),
in each of the plurality of protrusion portions (52), a flow path (54) communicating with the inner cavity (56) and at least one cooling hole (55) communicating with the flow path (54) and open to face the inner surface (34a) of the blade wall (34) are formed, and
in at least one cross section of the turbine blade (24/26) perpendicular to a blade height direction of the turbine blade (24/26) between a tip side edge (24b) and a hub side edge (24a) of the turbine blade (24/26), a length in which at least one protrusion portion (52) among the plurality of protrusion portions (52) extends from the outer surface of the insert (51) toward the inner surface (34a) of the blade wall (34) is defined as a length of the at least one protrusion portion (52), and in a case where the length of the at least one protrusion portion (52) is defined as L and an inner diameter of the at least one cooling hole (55) formed in the at least one protrusion portion (52) is denoted as d, L>5d is satisfied.

With the turbine blade according to the present disclosure, it is possible to increase a flow path cross-sectional area of a collection space without reducing a width of the flow path. Therefore, it is possible to enhance a reduction effect of a cross flow.

[2] The turbine blade according to another aspect is the turbine blade according to [1],
in which in the at least one cross section, in a case where an area of the inner cavity (56) is denoted as A₁ and a total area of the collection space (53) is denoted as A₂, A₁<A₂ is satisfied.

With such a configuration, it is possible to increase a flow path cross-sectional area of a collection space without reducing a width of the flow path. Therefore, it is possible to enhance a reduction effect of a cross flow.

[3] The turbine blade according to yet another aspect is the turbine blade according to [1] or [2],
in which a plurality of the cooling holes (55) are formed in each of the plurality of protrusion portions (52), and
the plurality of cooling holes (55) in each of the plurality of protrusion portions (52) are arranged in a row along an axial direction of the collection space (53).

With such a configuration, the direction of the cross wind changes due to the interference between the flow of the cooling medium jetted from the cooling hole located on the most upstream side with respect to the flow (cross wind) of the cooling medium crossing the flow of the cooling medium jetted from the cooling hole and the cross wind. Therefore, the interference between the flow of the cooling medium jetted from the cooling hole located on the downstream side for the cooling hole located on the most upstream side with respect to the cross wind, and the cross wind is weakened. As a result, the ability to cool the blade wall can be improved.

[4] The turbine blade according to yet another aspect is the turbine blade according to [3],
in which the plurality of protrusion portions (52) include
   a first protrusion portion (52a), and
   a second protrusion portion (52b) located adjacent to the first protrusion portion (52a), and
in a case where a plurality of virtual planes (IP₂) that pass through each of the plurality of cooling holes (55) formed in the first protrusion portion (52a) and that are perpendicular to the axial direction of the collection space (53) are assumed, each of the plurality of virtual planes (IP₂) passes between cooling holes (55, 55) adjacent to each other among the plurality of cooling holes (55) formed in the second protrusion portion (52b).

With such a configuration, it is possible to reduce a cooling unevenness of the entire inner surface of the blade wall.

[5] The turbine blade according to yet another aspect is the turbine blade according to any one of [1] to [4],
in which the plurality of protrusion portions (52) include
   a first protrusion portion (52a),
   a second protrusion portion (52b) located adjacent to the first protrusion portion (52a), and
   a third protrusion portion (52c) located adjacent to the second protrusion portion (52b) on a side opposite to a side of the first protrusion portion (52a) with respect to the second protrusion portion (52b), and
in the at least one cross section of the turbine blade (24/26) perpendicular to the blade height direction of the turbine blade (24/26) between the tip side edge (24b) and the hub side edge (24a) of the turbine blade (24/26), in a case where an inner diameter of at least one first cooling hole (55a) that is the at least one cooling hole (55) formed in the first protrusion portion (52a) is denoted as d₁, an inner diameter of at least one second cooling hole (55b) that is the at least one cooling hole (55) formed in the second protrusion portion (52b) is denoted as d₂, an inner diameter of at least one third cooling hole (55c) that is the at least one cooling hole (55) formed in the third protrusion portion (52c) is denoted as d₃, a pitch between a distal end of the first protrusion portion (52a) and a distal end of the second protrusion portion (52b) is denoted as X₁, and a pitch between the distal end of the second protrusion portion (52b) and a distal end of the third protrusion portion (52c) is denoted as X₂, [Expression 2] is satisfied.

$$\frac{{X}_{1}}{{d}_{1} + {d}_{2}} + \frac{{X}_{2}}{{d}_{2} + {d}_{3}} ≧ 10 \qquad [ Expression 2 ]$$

With such a configuration, in a cross section perpendicular to a length direction of the insert, as the pitch of the distal ends of the adjacent protrusion portions becomes larger, a flow rate of the cooling medium per unit area becomes smaller. Therefore, it is possible to efficiently cool the blade wall.

[6] The turbine blade according to yet another aspect is the turbine blade according to any one of [1] to [5],
in which, in a case where a virtual tangent plane (IP₁) in contact with the inner surface (34a) at a position (P_{L}) in which an axis (L₅₅) of the cooling hole (55) intersects the inner surface (34a) of the blade wall (34) is assumed, the axis (L₅₅) intersects the virtual tangent plane (IP₁) at an angle of 90°=10°.

With such a configuration, the cooling medium efficiently collides with the inner surface of the blade wall because the cooling holes are approximately surface-perpendicular to the inner surface of the blade wall, and thus the blade wall can be efficiently cooled.

[7] The turbine blade according to yet another aspect is the turbine blade according to any one of [1] to [6],
in which, in a case where a length of the flow path (54) in a direction in which the plurality of protrusion portions (52) are arranged is defined as a width of the flow path (54), a width of the flow path (54) at a position in which the flow path (54) is connected to the cooling hole (55) is defined as b, and the inner diameter of the cooling hole (55) is defined as d, b/d≥1.2 is satisfied.

With such a configuration, even in a case where the width d of the flow path varies in a case where the insert inserted in the turbine blade is molded by AM, by setting the ratio b/d of the width b of the flow path to the inner diameter of the cooling hole to 1.2 or more, it is possible to reduce a probability that the surface of the flow path is visible through the cooling hole in a case of viewing the inside (flow path) of the protrusion portion from the cooling hole. As a result, in a case where the blade wall is cooled by allowing the cooling medium to collide with the inner surface, the probability that the flow of the cooling medium flowing from the flow path into the cooling hole is disturbed is reduced. Therefore, it is possible to reduce the probability that the cooling efficiency of the blade wall is reduced.

[8] The turbine blade according to another aspect is the turbine blade according to [7],
in which b/d≤1.5 is satisfied.

In a case where the ratio b/d is excessively increased, the reduction effect of the cross flow is small, and the pressure loss due to contraction increases in a case where the cooling medium circulates from the flow path to the cooling hole. However, according to a configuration of [8], it is possible to suppress such an adverse effect as much as possible.

[9] The turbine blade according to yet another aspect is the turbine blade according to any one of [1] to [8],
in which in the at least one cross section, in a case where a distance between an opening of the cooling hole (55) facing the inner surface (34a) of the blade wall (34) and the inner surface (34a) is denoted as Z, 1<Z/d<5 is satisfied.

With such a configuration, it is possible to secure an area of the flow of the cooling medium crossing the flow of the cooling medium jetted from the cooling hole, and thus, there is a desirable effect on cooling of the blade wall.

### REFERENCE SIGNS LIST

24: stator blade (turbine blade)
24a: hub side edge
24b: tip side edge
26: rotor blade (turbine blade)
34: blade wall
34a: inner surface (of blade wall)
50: space
51: insert
52: protrusion portion
52a: first protrusion portion
52b: second protrusion portion
52c: third protrusion portion
53: collection space
54: flow path
55: cooling hole
55a: first cooling hole
55b: second cooling hole
55c: third cooling hole
IP₁: virtual tangent plane
IP₂: virtual plane

1. A turbine blade comprising:
a blade wall; and
an insert inserted into a space formed inside the blade wall,
wherein an inner cavity communicating with an outside of the turbine blade is formed inside the insert,
a plurality of protrusion portions protruding toward an inner surface of the blade wall are formed on an outer surface of the insert,
a collection space communicating with the outside of the turbine blade is defined between two adjacent protrusion portions among the plurality of protrusion portions,
in each of the plurality of protrusion portions, a flow path communicating with the inner cavity and at least one cooling hole communicating with the flow path and open to face the inner surface of the blade wall are formed, and
in at least one cross section of the turbine blade perpendicular to a blade height direction of the turbine blade between a tip side edge and a hub side edge of the turbine blade, a length in which at least one protrusion portion among the plurality of protrusion portions extends from the outer surface of the insert toward the inner surface of the blade wall is defined as a length of the at least one protrusion portion, and in a case where the length of the at least one protrusion portion is defined as L and an inner diameter of the at least one cooling hole formed in the at least one protrusion portion is denoted as d, L>5d is satisfied.

2. The turbine blade according to claim 1,
wherein in the at least one cross section, in a case where an area of the inner cavity is denoted as A₁ and a total area of the collection space is denoted as A₂, A₁<A₂ is satisfied.

3. The turbine blade according to claim 1,
wherein a plurality of the cooling holes are formed in each of the plurality of protrusion portions, and
the plurality of cooling holes in each of the plurality of protrusion portions are arranged in a row along an axial direction of the collection space.

4. The turbine blade according to claim 3,
wherein the plurality of protrusion portions include
a first protrusion portion, and
a second protrusion portion located adjacent to the first protrusion portion, and
in a case where a plurality of virtual planes that pass through each of the plurality of cooling holes formed in the first protrusion portion and that are perpendicular to the axial direction of the collection space are assumed, each of the plurality of virtual planes passes between cooling holes adjacent to each other among the plurality of cooling holes formed in the second protrusion portion.

5. The turbine blade according to claim 1,
wherein the plurality of protrusion portions include
a first protrusion portion,
a second protrusion portion located adjacent to the first protrusion portion, and
a third protrusion portion located adjacent to the second protrusion portion on a side opposite to a side of the first protrusion portion with respect to the second protrusion portion, and
in the at least one cross section, in a case where an inner diameter of at least one first cooling hole that is the at least one cooling hole formed in the first protrusion portion is denoted as d₁, an inner diameter of at least one second cooling hole that is the at least one cooling hole formed in the second protrusion portion is denoted as d₂, an inner diameter of at least one third cooling hole that is the at least one cooling hole formed in the third protrusion portion is denoted as d₃, a pitch between a distal end of the first protrusion portion and a distal end of the second protrusion portion is denoted as X₁, and a pitch between the distal end of the second protrusion portion and a distal end of the third protrusion portion is denoted as X₂, [Expression 1] is satisfied.
$$\frac{{X}_{1}}{{d}_{1} + {d}_{2}} + \frac{{X}_{2}}{{d}_{z} + {d}_{3}} ≧ 10 \qquad [ Expression 1 ]$$

6. The turbine blade according to claim 1,
wherein, in a case where a virtual tangent plane in contact with the inner surface at a position in which an axis of the cooling hole intersects the inner surface of the blade wall is assumed, the axis intersects the virtual tangent plane at an angle of 90°±10°.

7. The turbine blade according to claim 1,
wherein, in a case where a length of the flow path in a direction in which the plurality of protrusion portions are arranged is defined as a width of the flow path, a width of the flow path at a position in which the flow path is connected to the cooling hole is defined as b, and the inner diameter of the cooling hole is defined as d, b/d≥1.2 is satisfied.

8. The turbine blade according to claim 7,
wherein b/d≤1.5 is satisfied.

9. The turbine blade according to claim 1,
wherein in the at least one cross section, in a case where a distance between an opening of the cooling hole facing the inner surface of the blade wall and the inner surface is denoted as Z, 1<Z/d<5 is satisfied.
